(19) United States
(12) Patent Application Publication
(10) Pub. No.: US 2017/0163511 A1
(43) Pub. Date: Jun. 8, 2017

(54) INTEGRATED METHOD AND SYSTEM FOR REAL TIME BI-DIRECTIONAL COMMUNICATIONS OF ISSUES, CONCERNS, PROBLEMS, CRITICISMS, COMPLAINTS, FEEDBACK, OR COMPLIMENTS AND MANAGING, TRACKING, RESPONDING AND AUTOMATING RESPONSES TO SAME

(71) Applicant: Satisfi Holdings Inc., New York, NY (US)

(72) Inventors: David MONTOYA, Westport, CT (US); Neal MAGNUS, Montvale, NJ (US); Rungson SAMROENGRAJA, Darien, CT (US)

(21) Appl. No.: 15/442,306

(22) Filed: Feb. 24, 2017

Related U.S. Application Data
(63) Continuation of application No. 14/039,563, filed on Sep. 27, 2013, now abandoned.
(60) Provisional application No. 61/707,006, filed on Sep. 28, 2012.

(51) Int. Cl. H04L 12/26; G06N 99/00; G06Q 50/00; G06K 7/14; H04W 4/02; G06Q 30/02

(52) U.S. Cl. CPC H04L 43/0876; H04W 4/02; H04L 43/16; G06Q 30/0282; G06Q 30/0202; G06Q 50/01; G06K 7/1417; G06N 99/005

(57) ABSTRACT

A method and system whereby an Individual can communicate with an organization, business, service provider, healthcare provider or other enterprise (“Enterprise”) wherein the Enterprise can in turn manage, track, respond to, and automate responses to the communication of the Individual. This bi-directional communication can be conducted using a mobile device such as a smart phone or tablet or through a computer connected to the Internet. The Enterprise has a dashboard-like software application to manage, track, measure, and respond to the Individual that has initiated the communication. The Individual may choose to communicate anonymously with the communication stream moving through a third-party server which can serve as an anonymous proxy for the Individual.

### CROSS-REFERENCE TO RELATED APPLICATION

This application claims the benefit under 35 USC 119 of U.S. Provisional Patent Application Ser. No. 61/707,006 filed Sep. 28, 2013, the entire disclosure of which is hereby incorporated by reference in its entirety.

### FIELD OF THE INVENTION

The disclosed technology relates to a method and system whereby an Individual (“Individual,” which can be a client, user, customer, patient, employee, other company, etc.) can communicate with an organization, business, service provider, healthcare provider governmental agency or other enterprise (“Enterprise”) and the Enterprise can in turn manage, track, respond to, and automate responses to this communication. This bi-directional communication can be conducted using a mobile device such as a smart phone or tablet or through computer connected to the Internet. The Enterprise has a dashboard-like software application to manage, track, measure, and respond to the Individual that has initiated the communication. The Individual may choose to communicate anonymously with the communication stream moving through a third party server which can serve as an anonymous proxy for the Individual. The Individual may attach an image such as a photograph or video or voice message to the communication.

### BACKGROUND INFORMATION

Historically, eliciting feedback from and communicating with Individuals has been one of the biggest challenges a business, service provider, healthcare provider, governmental agency or other enterprise (“Enterprise”) faces. With the increasing prevalence of social media and the web, in general, responding to consumer/client dissatisfaction or needs, communicating with employees, or providing advice quickly and efficiently is more critical than ever in order to remain competitive in today's market place. A single negative posting in any of the numerous social media outlets can result in significant loss of business magnifying the impact far beyond losing a single client. For example, multi-unit franchise owners de facto cannot be in all of their locations simultaneously. Therefore, they are interested in learning of any issues or complaints that arise when they are not present and, in an attempt to resolve the problem or issue, respond back, in real time, to the Individual who is lodging the complaint. Alternatively, service or healthcare providers may wish to provide advice or counsel to their patients or in response to a communication from them. Frequently, an Individual wants to communicate with someone in the organization who can help them but does not know who has the authority to do so and how best to contact that person.

Responding to communications can be very labor intensive and, thereby, cause a delay by an Enterprise in responding to communications from an Individual. Therefore, an automated response system potentially employing logic based on a data repository of previous communications would enable the Enterprise to more efficiently respond and do so more rapidly. Likewise, for the Individual wishing to communicate with the Enterprise, identifying the correct person to contact and their contact information can be a daunting task.

There is a need in the art, therefore, for a method and system for real time, bi-directional communication of issues, concerns, problems, criticisms, complaints, feedback, or compliments and managing, tracking, responding to, and automating responses to same.

### SUMMARY

Some embodiments of the present invention are described below.

In one embodiment an Enterprise creates and displays signage containing a Quick Response (QR) code advising the Individuals that they can communicate with the Enterprise by scanning the QR code with a mobile device such as a smart phone or tablet device. When the code is scanned the Individual is automatically connected to a mobile screen or website specifically designated for that Enterprise. Alternatively, the communication can be initiated using a mobile application, or through the web from a computer connected to the internet. A dialogue screen containing content specific to the Enterprise is displayed and the Individual can communicate by picking items from a list or typing free-form. Additionally, the Individual can attach various media (pictures, video, voice message, etc.) to the communication. The communication can be routed through a central server, which can act as an anonymous proxy for the Individual and then routed to the Enterprise. The communication can trigger one or a plurality of emails, texts, or phone calls to one or a plurality of employees designated by the Enterprise. Once received, the Enterprise employee can then respond back through the central server in a number of different modalities including via text, email, etc. In one embodiment the Individual that wishes to initiate communication with an Enterprise can use his social media account to supply log-in credentials and responses can be routed back through the social media account. In one embodiment if an Enterprise does not respond to the Individual the communication can be routed to and disseminated through one or a plurality of social media outlets (Facebook, Twitter, Yelp) designated by the Individual or automated by the server.

An Individual can initiate communication with an Enterprise by entering a code number unique to the Enterprise rather than scanning a QR code. Yet another alternative is for an Individual interested in communicating with an Enterprise to use the system to do a search of Enterprises based on their geographic location as indicated by their smart phone or tablet device. Enterprises, in proximity to the Individual's geographic coordinates will be displayed in either a list or map view. The Individual can then select the Enterprise and initiate communication. The method may additionally allow the Enterprise to create automatic responses to certain types or all communications. Specific types of communication such as a complaint about poor food quality may have one automatic response whereas a complaint regarding poor service may have a different automatic response. In one embodiment the system may search a database of past communications and their corresponding responses to create a machine generated automatic response. The method may provide the Enterprise with a dashboard-like interface that allows it to track, sort, analyze, and manage the communications it has received. In addition, the dashboard may allow the Enterprise to designate certain employees to receive notification of incoming communications as well as assigning other administrative duties and or permissions to access all or certain parts of the system.

The method may additionally comprise storing past communications and their corresponding responses in a centralized or decentralized data repository. Additionally, the method may comprise, after a predetermined time interval, generating an automatic or machine selected response when no other response has occurred. The machine generated response may be based at least in part on stored data indicative of past responses to similar requests.

The method may additionally comprise the ability to transmit a coupon or some other form of benefit to the Individual that has initiated the communication. For example, an Individual who has transmitted a complaint regarding poor food might receive a coupon for a free dessert. Additionally, the method may comprise a data gathering or surveying capability where a survey instrument may be served up to the Individual that has initiated communication with the Enterprise.

In another embodiment, there is a non-transitory computer readable medium storing computer readable program code embodied therein for a method and method and system for real time, bi-directional communication of issues, concerns, problems, criticisms, complaints, feedback, or complements and managing, tracking, responding to, and automating responses to same.

In another embodiment based on the QR code scanned, code entered or geo-location of the Individual associate that communication with a specific Enterprise or a specific Individual and thereby link it with data stored in disparate computer systems regarding that Individual or Enterprise.

In another embodiment, an Individual sends a transmission about an Enterprise where such Enterprise is not a member of the network and such transmission is communicated to an Enterprise that is a member of the network based upon certain criteria (for example, geographic proximity, type of sales lead desired, type of competitor about whom the Individual is sending a transmission).

According to a further embodiment, a survey instrument that is relevant and customized to an Individual's location, preferences, or other historical data is served to the Individual. For example an Individual might scan, with the smart phone, a QR code located in a rental car. A survey instrument could then be served up via the smart phone that is specific to the make and model of the car, the car's drop off location, it could have questions that would allow an Individual to report that the windshield wiper fluid was empty, the radio wasn't working, or provide other feedback. The survey instrument could be modified based on any of a plurality of other data points.

### BRIEF DESCRIPTION OF THE DRAWINGS

FIG. 1 is a block diagram of an example configuration of an embodiment of a method for Individual's transmission of data to an information recipient.

FIGS. 2, 2A, 2B and 2C are an example of one embodiment of a flow diagram of the methods to respond to a Individual's transmission of data shown in FIG. 1.

FIG. 3 is a block diagram of an embodiment of a method to display Individual's transmissions.

FIG. 4 is a block diagram of an embodiment of a method to analyze Individual's transmissions.

FIG. 5 is a block diagram of an embodiment of a method to anticipate future Individual's transmissions.

FIGS. 6A, 6B, 6C, 6D, 6E, 6F, 6G, 6H and 6I are example screen displays of a system that embodies the method shown in FIG. 1.

FIGS. 7A and 7B are example screen displays of a system that embodies the methods shown in FIGS. 2, 2A and 2B.

FIGS. 8A, 8B, 8C, 8D and 8E are example screen displays of a system that embodies the method shown in FIG. 3.

FIGS. 9A, 9B, 9C, 9D and 9E are example screen displays of the web portal of the system shown in FIG. 11.

FIG. 10 is a block diagram of an embodiment of a method to share an Individual's transmission of data directed to a non-member Enterprise to a member Enterprise.

FIG. 11 is a block diagram of an example configuration of an embodiment of a system for real time bi-directional communications of issues, concerns, problems, criticisms, complaints or compliments and managing, tracking, responding and automating responses to same.

FIG. 12 is a block diagram of an example configuration of components of an embodiment of a portion of the system shown in FIG. 11.

### DETAILED DESCRIPTION

The following description presents certain specific embodiments of the present invention. However, the present invention may be embodied in a multitude of different ways as described herein or as defined and covered by the claims. In this description, reference is made to the drawings wherein like parts are designated with like numerals throughout.

The system can run on any computer. An exemplary configuration of components is described herein below. The system is comprised of various modules, tools, and applications as discussed in detail below. As can be appreciated by one of ordinary skill in the art, each of the modules may comprise various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system modules, tools, and applications may be written in any programming language such as, for example, C, C++, C#, BASIC, Visual Basic, Pascal, Ada, Java, HTML, XML, Ajax or FORTRAN, and executed on an operating system, such as variants of Windows, Macintosh, UNIX, Linux, VxWorks, or other operating system. C, C++, C#, BASIC, Visual Basic, Pascal, Ada, Java, HTML, XML, Ajax and FORTRAN are industry standard programming languages for which many commercial compilers can be used to create executable code.

### DEFINITIONS

The following provides a number of examples of terms used in describing certain embodiments of the system and method.

A network may refer to a network or combination of networks spanning any geographical area, such as a local area network (LAN), wide area network (WAN), regional network, national network, and/or global network. The Internet is an example of a current global computer network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communications service (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others.

A website may refer to one or more interrelated web page files and other files and programs on one or more web servers. In certain embodiments, the files and programs are accessible over a computer network, such as the Internet, by sending a hypertext transfer protocol (HTTP or HTTPS [S-HTTP]) request specifying a uniform resource locator (URL) that identifies the location of one of said web page files, wherein the files and programs are owned, managed or authorized by a single business entity. Such files and programs can include, for example, hypertext markup language (HTML) files, common gateway interface (CGI) files, and Java applications. The web page files preferably include a home page file that corresponds to a home page of the website. The home page can serve as a gateway or access point to the remaining files and programs contained within the website. In one embodiment, all of the files and programs are located under, and accessible within, the same network domain as the home page file. Alternatively, the files and programs can be located and accessible through several different network domains.

A web page or electronic page may comprise that which is presented by a standard web browser in response to an HTTP request specifying the URL by which the web page file is identified. A web page can include, for example, text, images, sound, video, and animation.

A computer or computing device may be any processor controlled device that permits access to a computer network such as the Internet, including terminal devices, such as personal computers, workstations, servers, clients, mini-computers, main-frame computers, laptop computers, a network of individual computers, mobile computers, palm-top computers, handheld computers, set top boxes for a television, other types of web-enabled televisions, interactive kiosks, personal digital assistants (PDAs), interactive or web-enabled wireless communications devices, mobile web browsers, or a combination thereof. The computers may further possess one or more input devices such as a keyboard, mouse, touch pad, joystick, pen-input-pad, and the like. The computers may also possess an output device, such as a visual display and an audio output. One or more of these computing devices may form a computing environment.

These computers may be uni-processor or multi-processor machines. Additionally, these computers may include a non-transitory addressable storage medium or computer accessible or readable medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, memory cards, electronic networks, and other techniques to transmit or store electronic content such as, by way of example, programs and data. In one embodiment, the computers are equipped with a network communication device such as a network interface card, a modem, or other network connection device suitable for connecting to the communication network. Furthermore, the computers execute an appropriate operating system such as Linux, UNIX, any of the versions of Microsoft Windows, Apple MacOS, IBM OS/2 or other operating system. The appropriate operating system may include a communications protocol implementation that handles all incoming and outgoing message traffic passed over the network. In other embodiments, while the operating system may differ depending on the type of computer, the operating system will continue to provide the appropriate communications protocols to establish communication links with the network.

The computers may contain program logic, or other substrate configuration representing data and instructions, which cause the computer to operate in a specific and predefined manner, as described herein. In one embodiment, the program logic may be implemented as one or more object frameworks or modules. These modules may be configured to reside on the addressable storage medium and configured to execute on one or more processors. The modules include, but are not limited to, software or hardware components that perform certain tasks. Thus, a module may include, by way of example, components, such as, software components, object-oriented software components, class components and task components, processes, functions, attributes, procedures, subroutines, segments of program code, drivers, firmware, microcode, circuitry, data, databases, data structures, tables, arrays, and variables.

The various components of the system may communicate with each other and other components comprising the respective computers through mechanisms such as, by way of example, interprocess communication, remote procedure call, distributed object interfaces, and other various program interfaces. Furthermore, the functionality provided for in the components, modules, and databases may be combined into fewer components, modules, or databases or further separated into additional components, modules, or databases. Additionally, the components, modules, and databases may be implemented to execute on one or more computers.

In the past, communicating feedback or issues from an Individual, such as a consumer or patient, to an establishment or service professional, has been difficult to do. In addition, from the consumer or patient perspective, it is nearly impossible to determine if the feedback is delivered to someone empowered to act on the feedback or information. In the case of a patient in the care of a service professional or provider, once away from the direct supervision of the professional, it is has proven very difficult to communicate relevant information in a timely fashion and in a format that allows analysis to ensure better patient outcomes.

In some instances, the Individual may wish to remain anonymous to the establishment receiving feedback, but still want to remain in contact to ensure that the feedback is acted on. In traditional feedback and communication systems, the Individual has had to provide some identifying information, such as an email address, to ensure that a response can be communicated back to the Individual.

The system and method solves the above-identified needs, as well as others, by providing for a closed-loop, automated system that enables bi-directional communication of information between an Individual and an enterprise, establishment, service provider or other professional. In addition, the communication can be set up in a such a way as to anonymize the Individual, yet still allow communication between the two-entities. For the enterprise, establishment, service provider or other professional, the system provides for methods to view and analyze communications from the Individual as well as the ability to set up automated responses based on the information received. Details of these and other advantages and novel features will be set forth in part in the description that follows, and in part will become more apparent to those skilled in the art upon examination of the following or upon learning by practice of the system and method.

This disclosure is not intended to limit the system and method to the case of an Individual with an enterprise, establishment, service provider or other professional. As will be recognized by those skilled in the art, other communications and processes may be integrated and managed using similar methods, and are intended to be included under this disclosure.

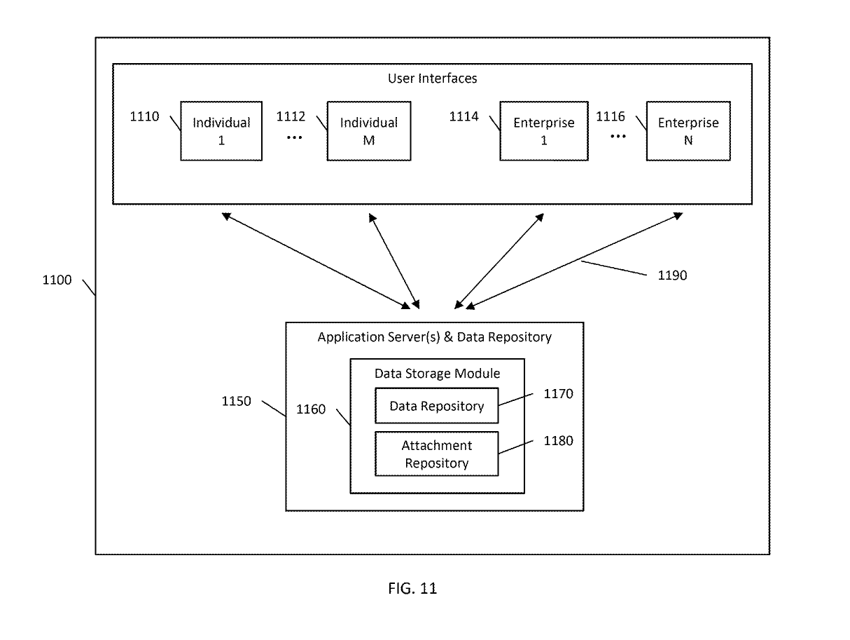

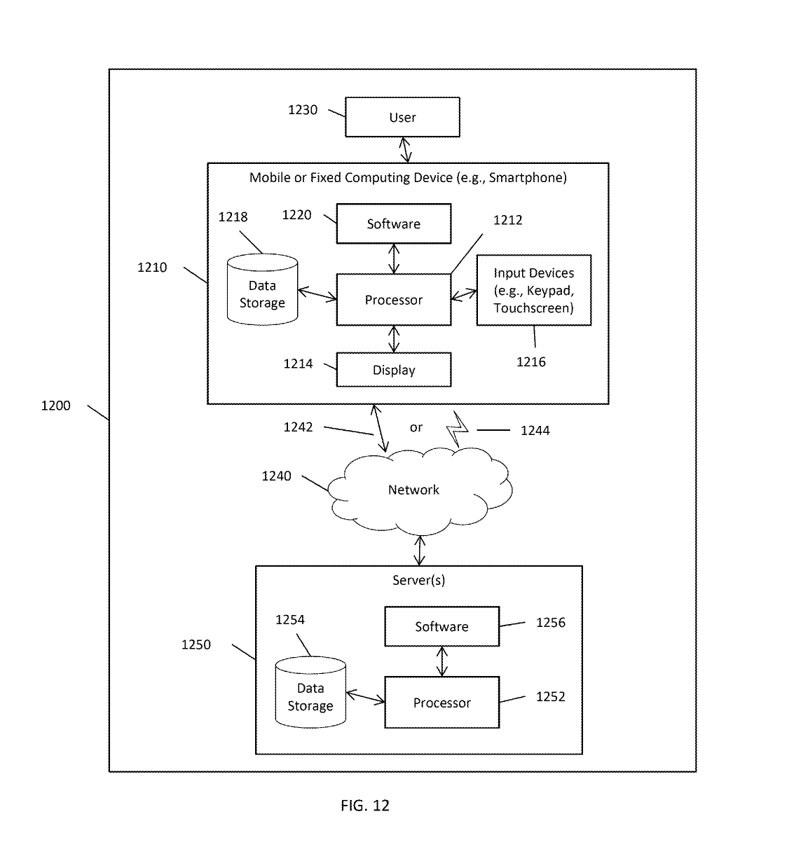

One embodiment is based on the exemplary open system integrated architecture 1100 shown in FIG. 11. Referring now to FIG. 11, the exemplary open system integrated architecture 1100 may be based on, for example, a User Interface interacting with a local or remote data repository and a local or remote application running on a local or remote application server, such as an application server 1150. The User Interface may operate on a computer or computing device (as described above). The User Interfaces, such as interface 1110 associated with User 1, interface 1112 associated with User M, interface 11114 associated with Enterprise 1, and interface 1116 associated with Enterprise N, for example, have interactive connections with a Data Storage Module 1160, which may contain a Data Repository 1170, such as a relational database, and an Attachment Repository 1180, such as a document array. The Data Storage Module 1160 may reside in the application server 1150 or may be in data communication with the application server 1150. The structure and functioning of each module will be described in connection with the embodiments that follow herein.

In one embodiment, a method and a system for real time bi-directional communications of issues, concerns, problems, criticisms, complaints or compliments and managing, tracking, responding and automating responses to same may be implemented as an Internet-based or other network-based system that allows an Individual of the system (e.g., consumer or patient) to input related data into the Data Repository Module 1160 via the User Interface, such as one of interfaces 1110-1116, which is connected to the system through, for example, a secure Internet connection 1190.

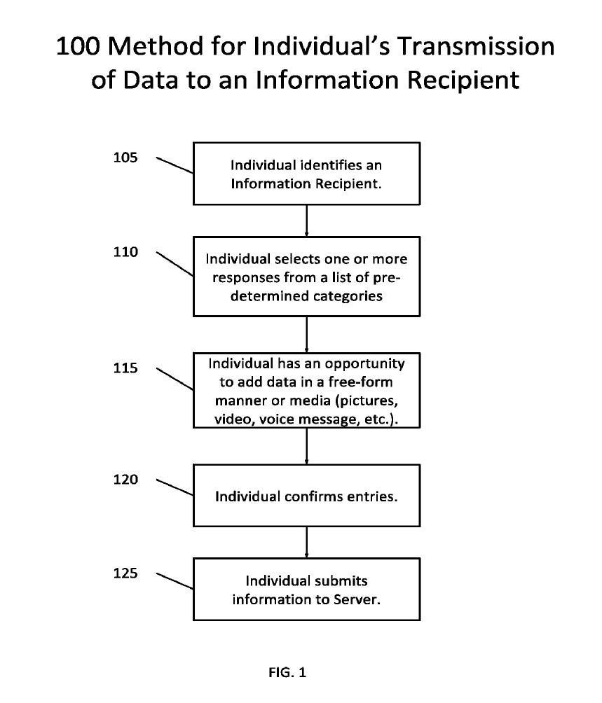

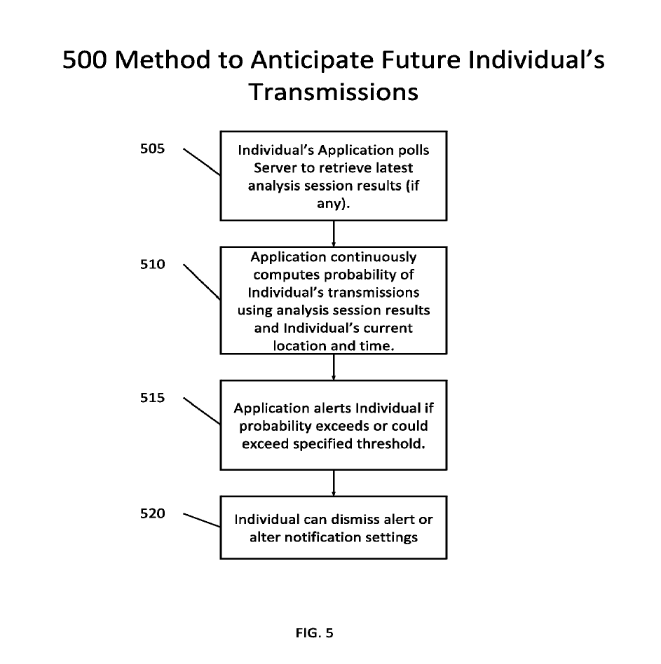

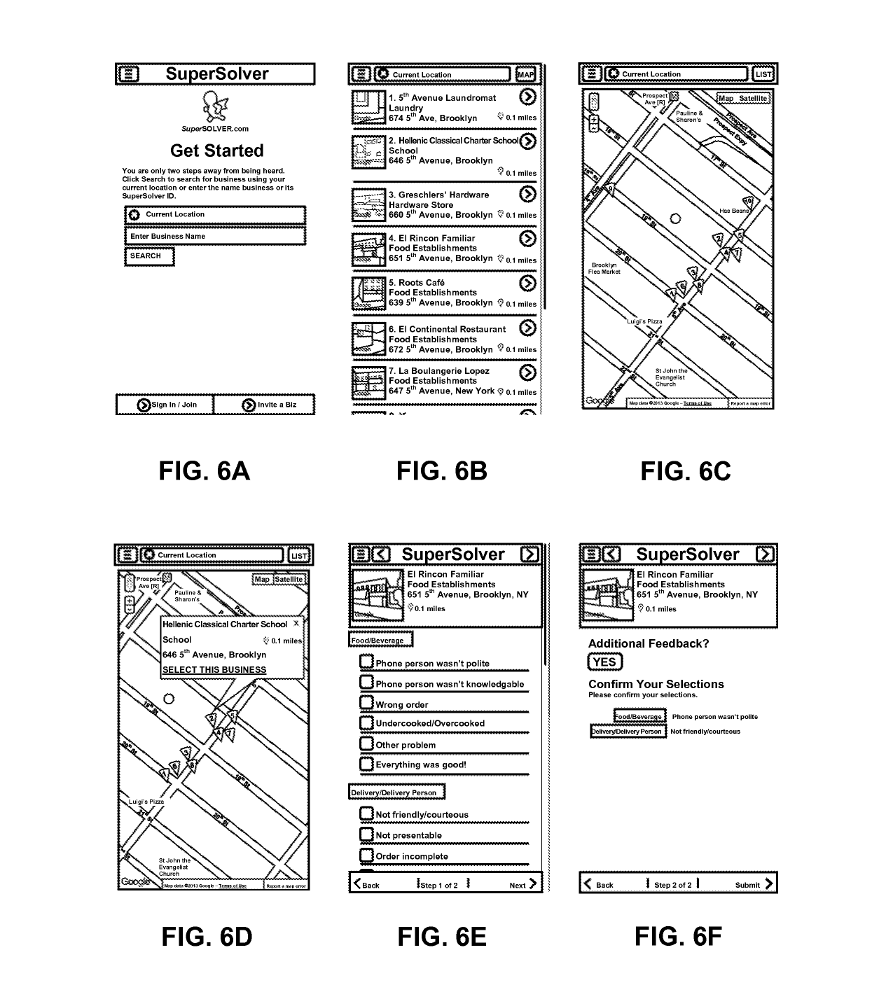

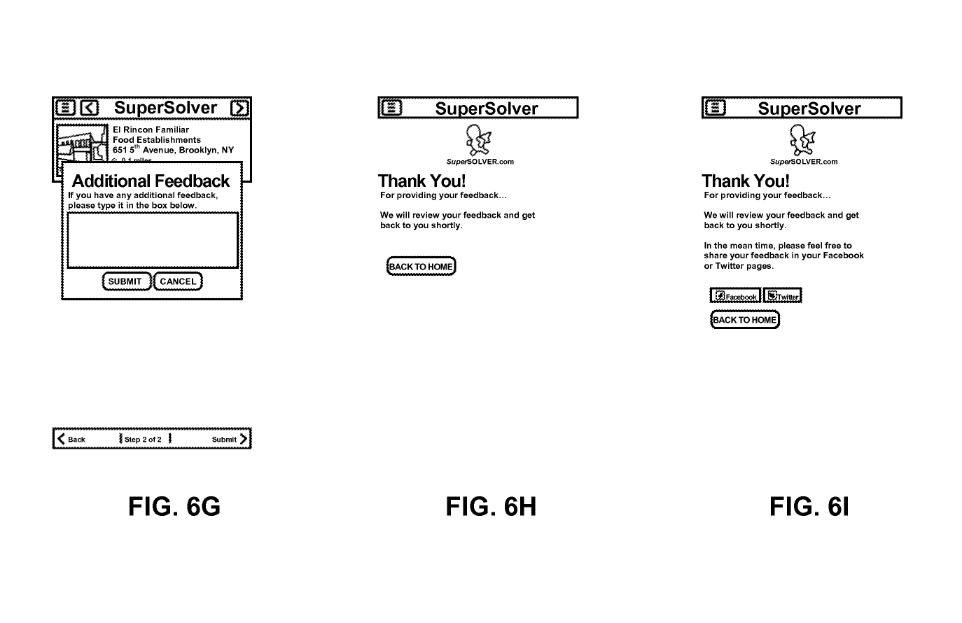

Referring to FIG. 1, a process 100 (Method for User Transmission of Data to an Information Recipient) will be described that may operate on the architecture 1100 described in FIG. 11. Beginning at a start state 105, process 100 begins when the Individual identifies an information recipient using one of the interfaces 1110-1112 (FIG. 11). FIGS. 6A through 6D show example screen displays, respectively, that allow an Individual to search for an Enterprise to be the information recipient. The example screen display can be displayed via one of the interfaces 1110-1112, for example. Additional detail about the screen displays in FIGS. 6A through 6D will be provided hereinbelow. In another embodiment, the Individual may also specify other Individuals as information recipients. For example, in this context, the Individual is a patient experiencing a stressful episode (such as an uncontrollable urge to eat) and is submitting a report not only to the Individual's healthcare professional, but to other Individuals who are in the submitting Individual's support group. This inclusion allows those Individuals various options to provide support to the submitting Individual.

Process 100 then proceeds to state 110 where information is entered, such as via one of the interfaces 1110-1112. FIG. 6E shows an example screen display that allows an Individual to specify the information to be transmitted from a list of pre-determined categories. Additional detail about the screen display shown in FIG. 6E will be provided hereinbelow. In another embodiment the information recipient may be specified using a QR code.

Process 100 continues to state 115, where the Individual has the option to enter free-form text, such as via one of the interfaces 1110-1112. FIG. 6F shows an example screen display that allows an Individual to enter free-form text when selecting the button marked “YES” under the section “Additional Feedback”. FIG. 6G shows an example screen display of where the Individual can enter free-form text. Additional detail about the screen displays shown in FIGS. 6F and 6G will be provided hereinbelow.

Process 100 then advances to state 120, where the Individual confirms the information to be transmitted to the information recipient, such as via one of the interfaces 1110-1112. FIG. 6F shows an example screen display that allows an Individual to confirm the information to be transmitted. Additional detail about the screen display shown in FIG. 6F will be provided hereinbelow.

Process 100 continues at state 125, where the Individual submits the information to the server. FIG. 6F shows an example screen display that shows the Submit button that submits information the Individual has specified to the server. FIGS. 6H and 6I show example screen displays, respectively, of what is displayed after a successful transmission of information to the server in the case where the information recipient has an account on the server and the case where the information recipient does not have an account on the server. Additional detail about the screen displays shown in FIGS. 6H and 6I will be provided hereinbelow.

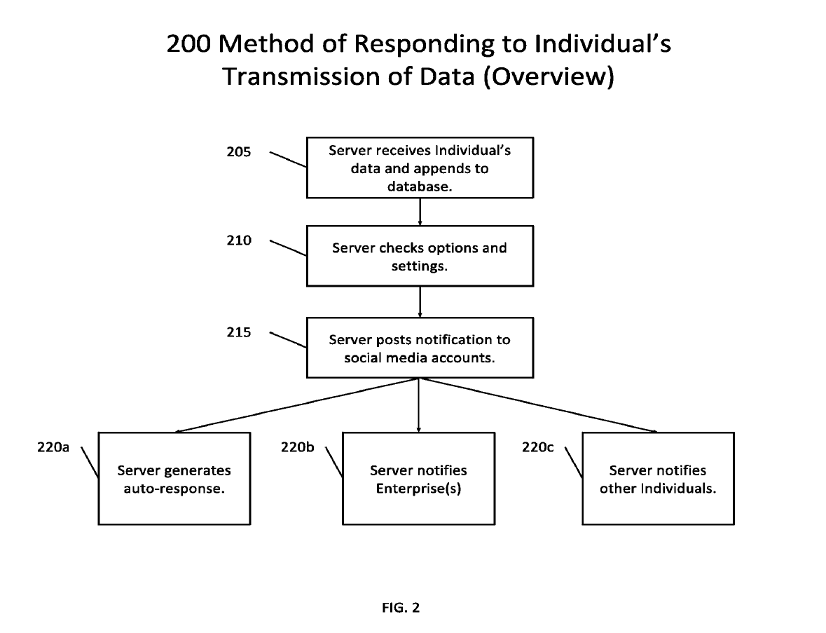

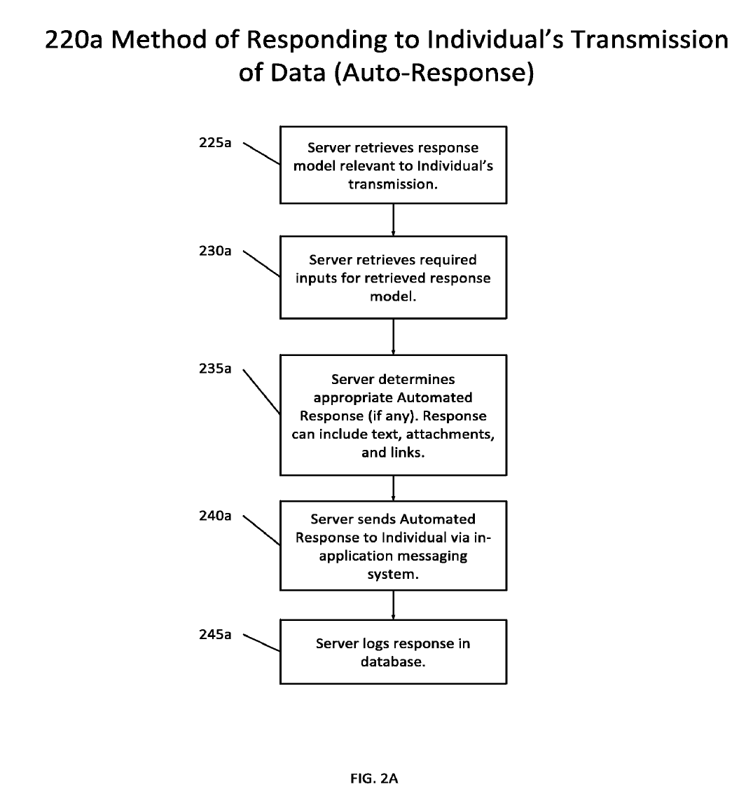

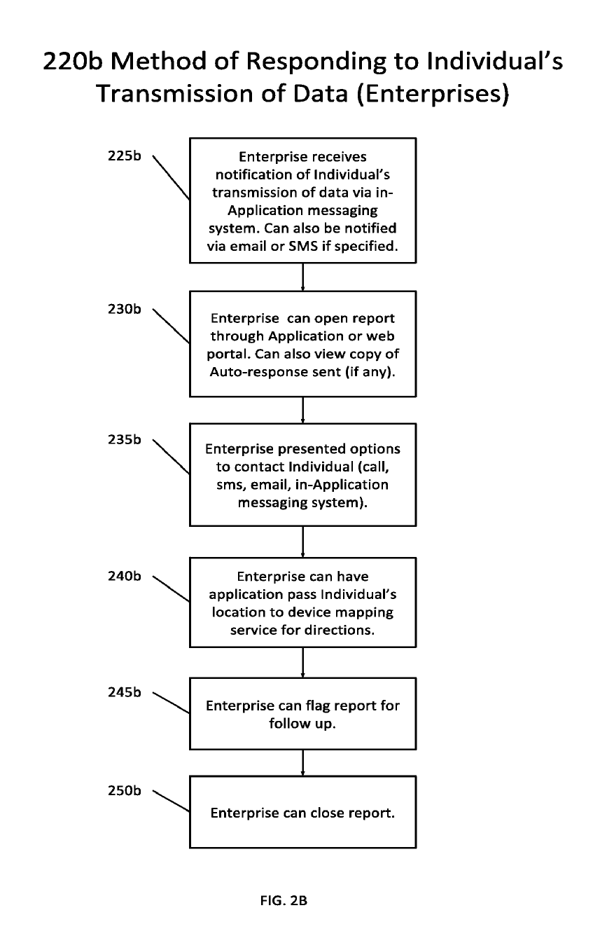

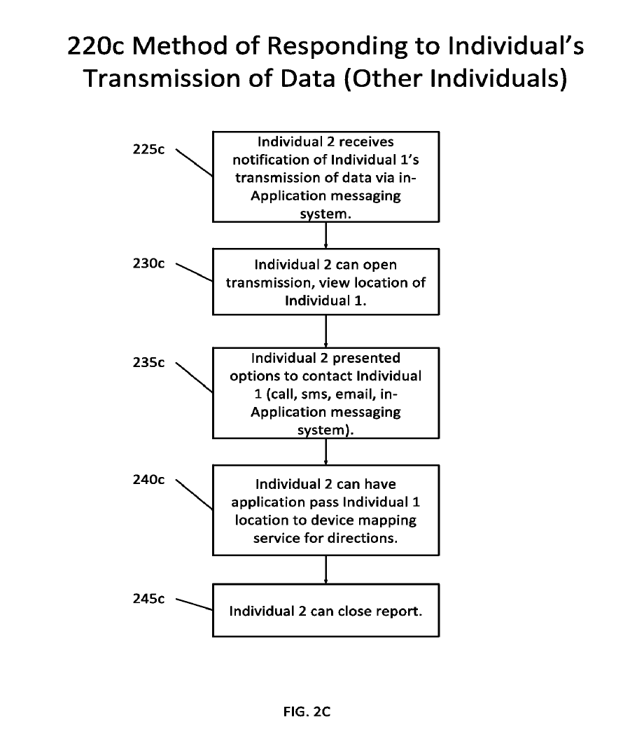

Referring to FIG. 2, a process 200 (Method for Responding to User Transmission of Data, Overview) will be described that may operate on the architecture 1100 described in FIG. 11. Beginning at a start state 205, the server receives the data transmitted by the Individual from state 125 and appends the information to the database, such as contained within a Data Storage Module 1160 described in FIG. 11.

Process 200 continues to state 210 where the server checks options and settings to confirm the list of information recipients and whether to post a subset of the transmission to social media accounts (e.g., Facebook, Twitter). For each information recipient (which can either be an Individual or an Enterprise), the server retrieves that recipient's options and settings which are stored in the database, such as contained within a Data Storage Module 1160 described in FIG. 11. Those options and settings are accessed by the Individual or Enterprise, such as via one of the interfaces 1110-1116. The posting to social media accounts is performed in state 215, if dictated by the options and settings. In one embodiment, where the Individual is submitting feedback to an Enterprise, the server checks if the Enterprise has an account on the server. If not, the Enterprise is a non-member Enterprise and a subset of the transmission is posted to social media accounts as dictated by the options and settings. Process 200 continues to states 220a, 220b and 220c depending on the options and settings confirmed in state 210.

Referring to FIG. 2A, a process 220a (Method of Responding to a User Transmission of Data—Auto-Response) will be described that may operate on architecture 1100 described in FIG. 11. Process 220a begins with state 225a, the server retrieves the relevant response model based on the Individual's transmission and the information recipient. A response model can be thought of as a process which will generate a response tailored to the Individual's transmission and other pertinent information. In one embodiment, the Individual is a patient who has submitted a transmission to their healthcare professional regarding a stressful episode (such as an uncontrollable urge to eat). An example response model is retrieved that depending on the information in the transmission (which is the input to the response model), will send a message containing supportive statements and links to resources to help the patient control their urge.

Process 220a then moves to state 230a, the response model determines what data is required as inputs and the server retrieves those inputs. Process 200 continues to State 235a, where the retrieved inputs are fed into the response model and the response model determines the form and content of the automated response.

In one embodiment, where the Individual is providing feedback to a specific Enterprise, the response model will, for example, use as inputs all previous transmissions by all Individuals to the specific Enterprise in the past month as well as the current Individual's transmission. A response will take the form of a variable text response with zero or more hyperlinks, zero or more attachments, such as contained in an Attachment Repository 11180 described in FIG. 11. In another embodiment, where the Individual is a patient providing information to a service provider, such as a healthcare professional, the response model will, for example, use as inputs all transmissions made by the same Individual in the past month, including the current transmission. A response will take the form of a variable text response with zero or more hyperlinks, zero or more attachments, such as contained in an Attachment Repository 11180 described in FIG. 11.

Process 220a moves to state 240a, the servers sends the automated response to the Individual via the in-application messaging system. The Individual may also be notified via email, SMS or other notification system. Process 220a ends with state 245a, the server logs a copy of the auto-response in the database, such as contained within a Data Storage Module A60 described in FIG. 11.

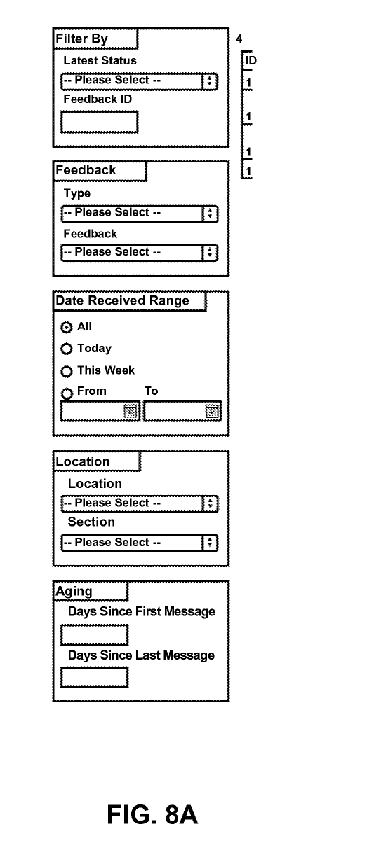

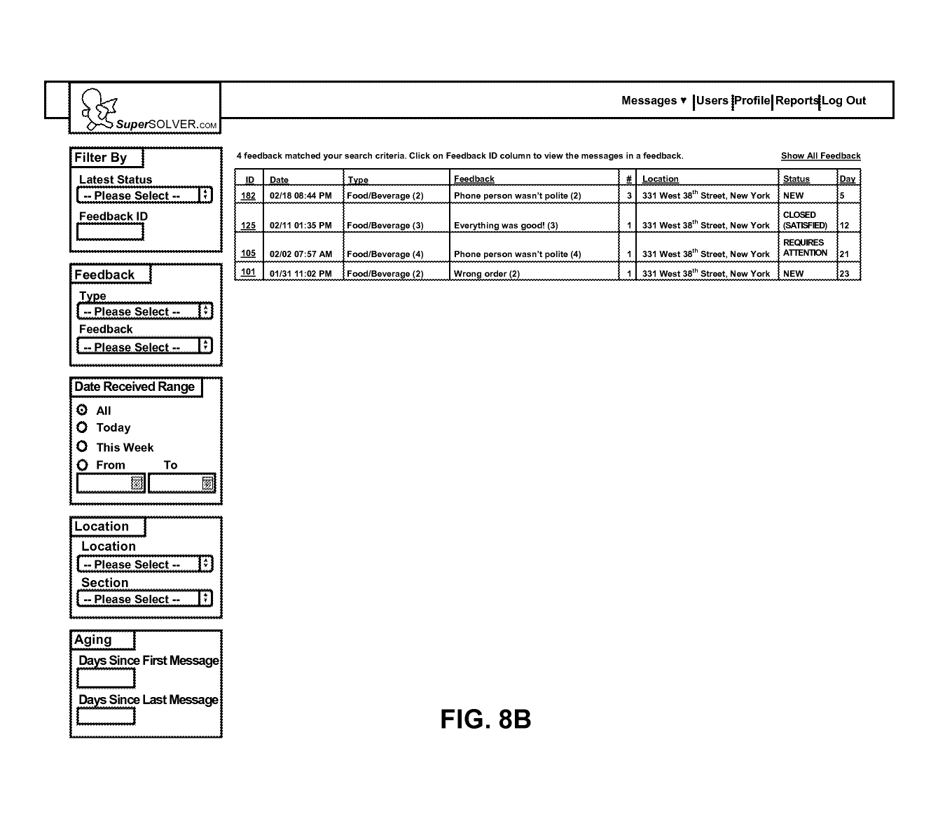

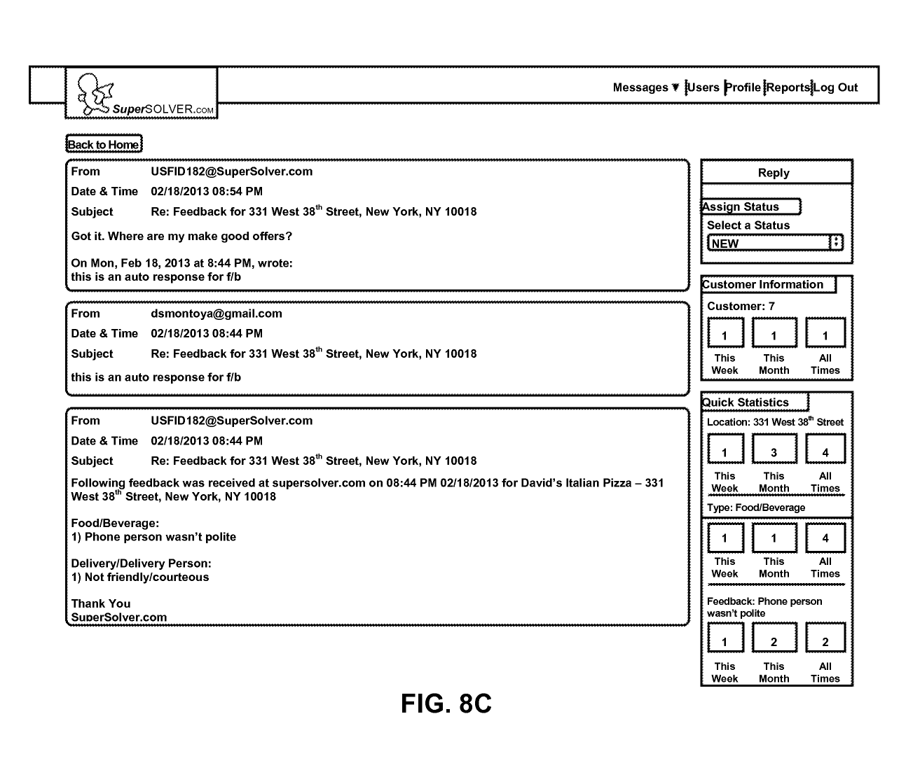

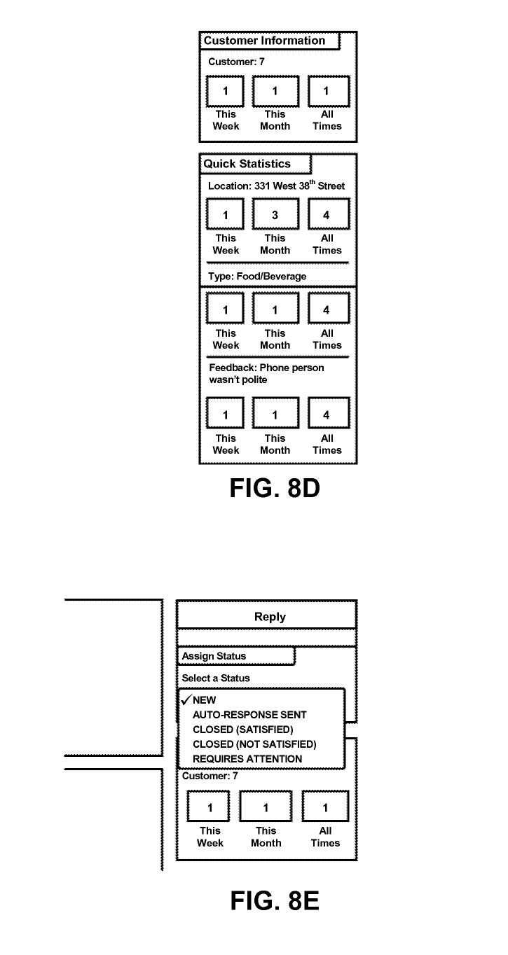

Referring to FIG. 2B, a process 220b (Method of Responding to a User Transmission of Data—Enterprise) will be described that may operate on architecture 1100 described in FIG. 11. Process 220b begins with state 225b, the Enterprise receives notification of Individual transmission of data via in-application messaging system, email, SMS or other notification system. Process 220b continues to state 230b, where the Enterprise accesses the Individual transmission report such as via one of the interfaces 1114-1116 in FIG. 11. FIG. 8B is an example screen display of an interface to display Individual transmissions to the Enterprise. Additional detail about the screen displays shown in FIG. 8B will be provided hereinbelow.

Process 220b continues to state 235b, the Enterprise can contact the Individual who transmitted the data via the in-application messaging system, SMS, email, voice (if accessing via a smartphone or like device) or other messaging system as specified.

Process 220b continues to state 240b, the Enterprise can pass the current Individual location (as contained within the Individual transmission of data) to a device mapping service for directions to reach the Individual (if accessing via a smartphone or like device with GPS).

Process 220b continues to state 245b, the Enterprise can flag the report for follow up. Process 220b ends with state 250b, the Enterprise can close the report.

Referring to FIG. 2C, a process 220c (Method of Responding to a Individual Transmission of Data—Other Individuals) will be described that may operate on architecture 1100 described in FIG. 11. Individual 1 represents the Individual that sent the transmission of data, Individual 2 represents a valid Individual which was specified as an information recipient by Individual 1. Process 220c begins with state 225c, Individual 2 receives notification of Individual 1's transmission of data via the in-application messaging system, email, SMS or other specified messaging system.

Process 220c continues to state 230c, where Individual 2 accesses the Individual transmission report such as via one of the interfaces 1110-1112 in FIG. 11. Continuing to state 235c, Individual 2 can contact Individual 1 via in-application messaging system, email, SMS, or voice (if accessing via a smartphone or like device).

Process 220c continues to state 240c, Individual 2 can pass the Individual 1's location (as contained within the Individual transmission of data) to a device mapping service for directions to reach the Individual (if accessing via a smartphone or like device with GPS). Process 220c ends with state 345c, Individual 2 can close the report.

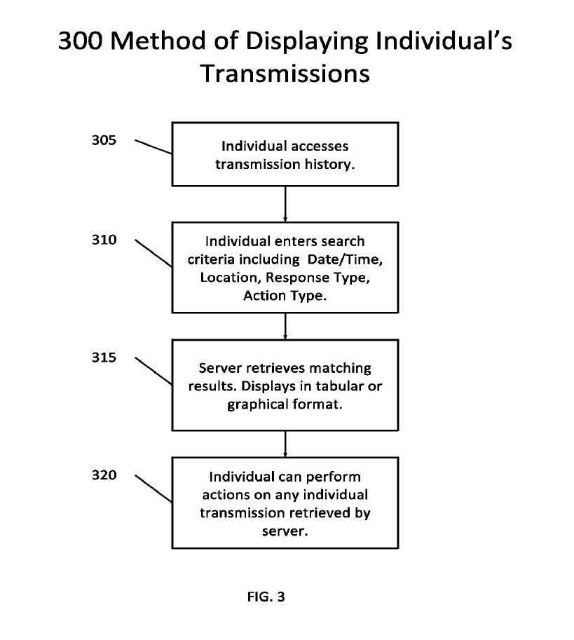

Referring to FIG. 3, a process 300 (Method of Displaying Individual Transmissions) will be described that may operate on architecture 1100 described in FIG. 11. Beginning at a start state 305, process 300 begins with state 305 when the Individual accesses transmission history, such as via one of the interfaces 1110-1116 (FIG. 11). In this context, the Individual may be a consumer or patient searching for a history of all transmissions made by that Individual to any Enterprise. In another context, the Individual may be the Enterprise or provider searching for all transmissions made to that Enterprise or provider.

Process 300 proceeds to state 310, the Individual enters search criteria including, but not limited to, Date/Time, Location, Response Type and Action Type. FIG. 8A shows an example screen display that allows a Individual to specify a search filter. Additional detail about the screen display shown in FIG. 8A will be provided hereinbelow.

Process 300 proceeds to state 315, the server retrieves matching results. These results can be displayed either in a tabular or graphical format. Graphical formats can include cluster displays or heat maps, which show density of interarrival times of Individual transmissions, transmissions overlaid onto a map, bar charts by response type, action type or location. FIG. 8B shows an example screen display that displays results in a tabular format. Additional detail about the screen display shown in FIG. 8A will be provided hereinbelow.

Process 300 ends with state 320, the Individual can perform actions on any individual transmission retrieved by the server. FIG. 8C shows an example screen display that allows a Individual to interact with one particular Individual transmission and the responses to that transmission—the collection of the transmission and the related responses is called a “thread”. Additional detail about the screen display shown in FIG. 8C will be provided hereinbelow.

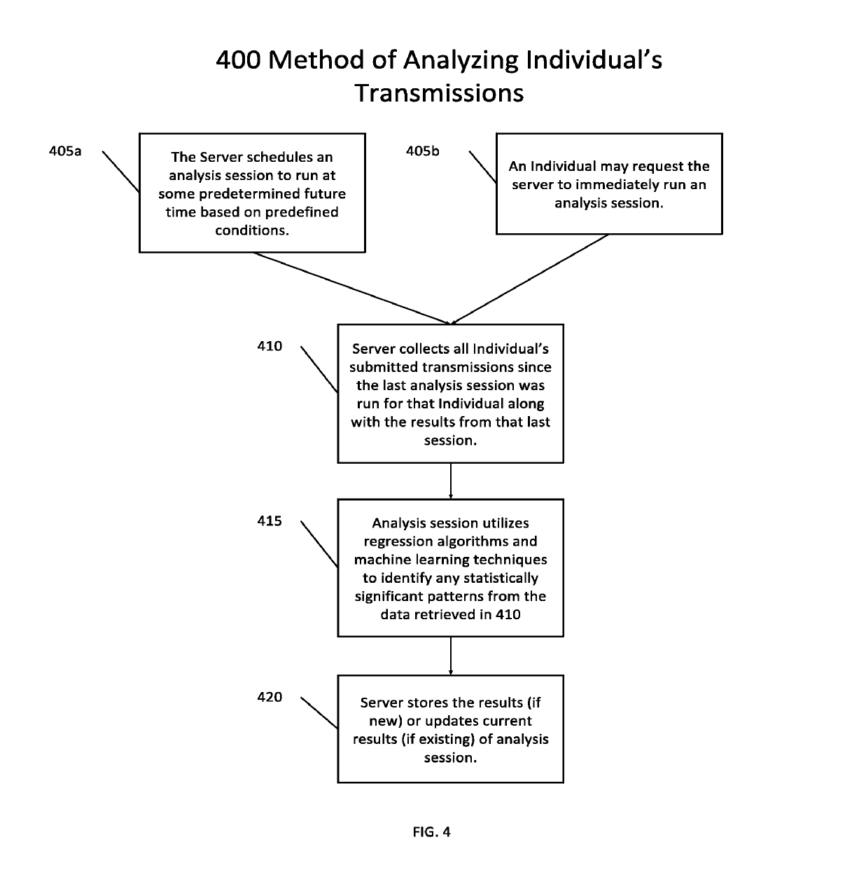

Referring to FIG. 4, a process 400 (Method of Analyzing Individual Transmissions) will be described that may operate on architecture 1100 described in FIG. 11. In one embodiment, an Enterprise will wish to analyze all Individual transmissions that have been directed to that Enterprise. In another embodiment, the Individual is a patient who has submitted Individual transmissions in the form of symptomatic occurrences of that patient. The patient or a service professional (such as a therapist) working with that patient may wish to analyze all Individual transmissions from that patient. In both embodiments, the outcome of the analysis session is to determine any statistically significant patterns within the set of transmissions to be analyzed. For example, an establishment may learn that a significant number of complaints are submitted at a certain location at a certain time of day on a particular day of the week.

Process 400 can be initiated in one of two ways. In state 405a, process 400 is scheduled for initiation by the server at some predetermined time based on predefined conditions. For example, the server will schedule analysis sessions for all enterprises, establishments and service professionals to run at a particular time (05:00 GMT) if and only if that Enterprise was an information recipient during the previous 24 hours. In state 405b, process 400 is manually initiated at the request of a Individual, such as via one of the interfaces 1110-1116 (FIG. 11). In this context, the Individual may be a consumer or patient, or Enterprise.

Process 400 continues to state 410, the server collections all relevant Individual submitted transmissions since the last analysis session was run along with the results from that last session. In the embodiment where the analysis is to be run on a particular Enterprise, the relevant Individual transmissions are all Individual transmissions submitted to that Enterprise within the proscribed time window. In the embodiment where the analysis is to be run on a particular Individual, the relevant Individual transmissions are all Individual transmissions submitted by that Individual within the proscribed time window.

Process 400 continues to state 415, the analysis session employs regression algorithms and/or machine learning techniques to identify any statistically significant patterns from the data retrieved in state 410. It will be obvious to those skilled in the art that there exist many techniques to determine statistical significance and the appropriate choice depends in large part to the form, quality and quantity of the data to be analyzed. Any algorithm or technique so employed will return an equation which computes the probability that an Individual transmission with certain characteristics will occur given a set of parameters including, but not limited to, time, location and previous Individual transmissions. In one embodiment, where the Individual is a patient who has submitted transmissions related to uncontrollable urges to eat, a Bayesian Network can be created to compute the conditional probability function that an uncontrollable urge to eat will occur given a particular time day, day of week, and geographic proximity to a certain location. The past transmissions provide the inputs which are used to create the Bayesian Network. The open-source program, OpenMarkov, is one example that can be incorporated into the Application Server 1150, described in FIG. 11, which can be used to create the Bayesian Network and compute the probability function.

Process 400 ends with state 420, the server stores the results (if new) or updates current results (if existing) of the analysis session to the database, such as contained within a Data Storage Module 1160 described in FIG. 11.

Referring to FIG. 5, a process 500 (Method to Anticipate Future Individual Transmissions) will be described that may operate on architecture 1100 described in FIG. 11. Process 500 begins with state 505, Individual's application communicates with server to retrieve latest analysis session results (if any). The Individual's application may be set to communicate with the server in this manner on an automated basis (e.g., once every 24 hours) or the Individual may initiate the action, such as via one of the interfaces 1110-1112 (FIG. 11).

Process 500 continues to state 510, the Individual's application continuously computes the probability of a Individual transmission of data based on Individual's current location and time. This information can be obtained if the Individual's application is on a smartphone or like device with GPS. In one embodiment, where the Individual is a patient, previous transmissions of data could indicate a pattern of occurrences where the patient often feels a strong urge to perform a detrimental action within proximity to a certain location at a certain time of day.

Process 500 continues to state 515, if the probability that under current conditions or if those conditions are soon to be met (for example, Individual is approaching a certain location or nearing a certain time of day or particular day of week or calendar date) exceed a specified threshold, Individual's application will generate an alert notifying Individual. For example, in the embodiment where the Individual is a patient and has submitted transmissions regarding uncontrollable urges to eat and has previously executed Process 400, the results of Process 400 indicate that the probability that this Individual experiences an uncontrollable urge to eat is 53% when the time of day is between 2-3 pm, the day of the week is between Monday to Friday, the Individual is within 5 miles of the geographic center of Rye, N.Y. The Individual's application will display a warning when 2 of the above conditions are met and the 3rd condition is close to being met (for example, the Individual is within 10 miles of Rye, N.Y. given the application has access to GPS, such as through a smartphone or like device). Process 500 ends with state 520, Individual can dismiss alert or alter notification settings, such as via one of the interfaces 1110-1112 (FIG. 11).

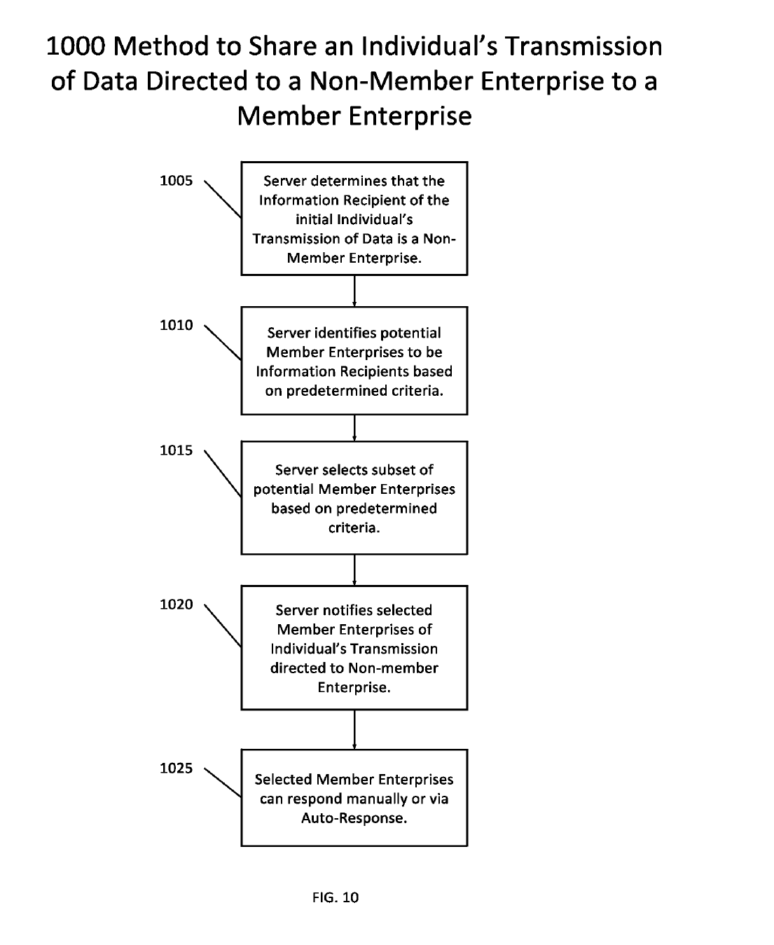

Referring to FIG. 10, a process 1000 (Method to Share a User Transmission of Data Directed to a Non-Member Enterprise to a Member Enterprise) will be described that may operate on architecture 1100 described in FIG. 11. In one embodiment, where a Individual is submitting a complaint or compliment or other issue about an Enterprise, the Enterprise in question may not be a Member Enterprise, i.e., the Enterprise does not have an account on the server and is considered a Non-member Enterprise. This method allows that complaint to be directed to a Member Enterprise, which may be interested in providing some form of inducement to convince the Individual to do business or communicate with the Member Enterprise. An inducement can come in the form of a coupon attached to a reply sent through the in-application messaging system, for example. Process 1000 begins with state 1005, after the server receives an Individual's transmission of data, the server determines the information recipient is a Non-member Enterprise.

Process 1000 continues to state 1010, the server identifies potential Member Enterprises to be information recipients of the current Individual's transmission based on predetermined criteria. Example criteria include, but are not limited to, a Member Enterprise's desire to receive such transmissions, transmission is in the form of a complaint or compliment or other issue, Non-Member Enterprise is in geographic proximity to Member Enterprise, is in similar business segment with Member Enterprise.

Process 1000 continues to state 1015, the server selects a subset of potential Member Enterprises to be an “information recipient” of the current Individual's transmission based on predetermined criteria. In one embodiment, this selection is driven off a scoring methodology, where the top X scores are chosen as information recipients, where X is a predetermined number. The scoring methodology awards higher scores for closer geographic proximity among other possible criteria. In another embodiment, the information recipients are chosen based off a bidding process where Member Enterprises have indicated the amount they are willing to pay for Individual's transmissions of the type matching the current Individual transmission.

Process 1000 continues to state 1020, the server notifies the selected subset of Member Enterprises from state 1015 of the Individual transmission. Process 1000 ends with state 1025, selected Member Enterprises can respond manually or via Auto-response as outlined in process 220b and 220a, respectively.

In one embodiment, one or more computer systems capable of carrying out the functionality are described herein. An example of such a computer system is shown in FIG. 12.

Exemplary System Configuration

Referring to FIG. 12, an exemplary configuration 1200 of components of an embodiment of the system will now be described. A mobile or fixed computing device 1210 is operated by a Individual 1230. The User Interface, such as interfaces 1110-1116, shown in FIG. 11 can be implemented on the mobile or fixed computing device. The computing device 1210 can be a handheld computing device or other portable computing device such as a smartphone or tablet computing device (e.g., Apple iOS device, Android device, Windows RT device), or a PC having a display. The computing device 1210 in certain embodiments operates in a stand-alone (independent) manner. In other embodiments, the computing device 1210 is in communication with one or more servers 1250 via a network 1240, such as the application server 1150 shown in FIG. 11. The server(s) include one or processors 1252, data storage 1254, such as the Data Storage Module shown in FIG. 12, and system software 1256 executed by the processor(s). In certain embodiments, the data storage 1254 stores one or more databases used by the system, and stores records. The processor(s) 1252 are in communication with the database(s) via a database interface, such as structured query language (SQL) or open database connectivity (ODBC). In certain embodiments, the data storage 1254 is not included in server(s) 1250, but is in data communication with the server(s) via the database interface. The connection from the computing device 1210 to the network 1240 can be a wireless or a satellite connection 1244 or a wired or direct connection 1242. In certain embodiments, the server(s) are part of a website, such as on an intranet or the Internet.

When the computing device 1210 is connected with the server(s) 1250, the web site may optionally provide updates on new features. In another embodiment, the computing device runs only when connected to the server(s) 1250.

The computing device 1210 includes a processor 1212, a display 1214, and one or more input devices 1216. The processor 1212 is in data communication with a data storage 1218 for storing data used by the system. In certain embodiments, the data storage 1218 stores records. In other embodiments, the data storage includes one or more databases. System software 1220 is executed by the processor 1212. The system software 1220 includes an application graphical user interface (GUI). The application GUI can include a database interface to the data storage 1218 of the computing device. In certain embodiments, the software is loaded from the data storage 1218. In embodiments where the computing device 1210 communicates with a website, the processor utilizes browser software in place of or in addition to the software 1220.

Example User Interface Screens

A graphical presentation of example graphical user interface (GUI) screens reflecting functions performed in accordance with an exemplary embodiment of the system and method will now be described.

FIG. 6A shows one embodiment of an example screen display that allows an Individual to search for an Enterprise to provide feedback to. The User searches for the Enterprise (Business) that he wants provide Feedback on using the following parameters:
By Business Name
By Address
By Nearby/Proximity

Mobile App submits the parameter provided above to a mapping database (such as Google Places API). The API returns a result-set of Google Businesses.

FIG. 6B shows another embodiment of an example screen display that shows search results. Mobile App displays the result set returned by the mapping database (such as Google Places API) in List View sorted:
By relevance, IF the User searches by Business Name
By distance to provided address, IF the User searches by Address
By proximity to User's location IF the User searched by Nearby/Proximity.

FIGS. 6C and 6D show another embodiment of example screen displays that show search results via a map interface. The User can click on the Map button to view the result set rendered on a map through the mapping database (such as Google Places API).

FIG. 6E shows another embodiment of an example screen display that allows an Individual to provide feedback to an Enterprise. Screen is displayed when the User selects a Business in either Map View or List View. Screen 1 allows the User to provide Feedback on the Business that he selected. The Feedback can include ONE or MORE Sub-Complaints grouped ONE or MORE Main Complaints.

FIG. 6F shows another embodiment of an example screen display that allows an Individual to provide/type additional Feedback (in addition to Main Complaints and Sub-Complaints) and Confirm the Individual's Feedback.

FIG. 6G shows one embodiment of an example screen display that allows an Individual to enter free-form text in the form of additional feedback to the Enterprise.

FIGS. 6H and 6I show, respectively, one embodiment of example screen displays that appear after an Individual has submitted feedback in the case where the Enterprise has an account on the server and the case where the Enterprise does not have an account on the server.

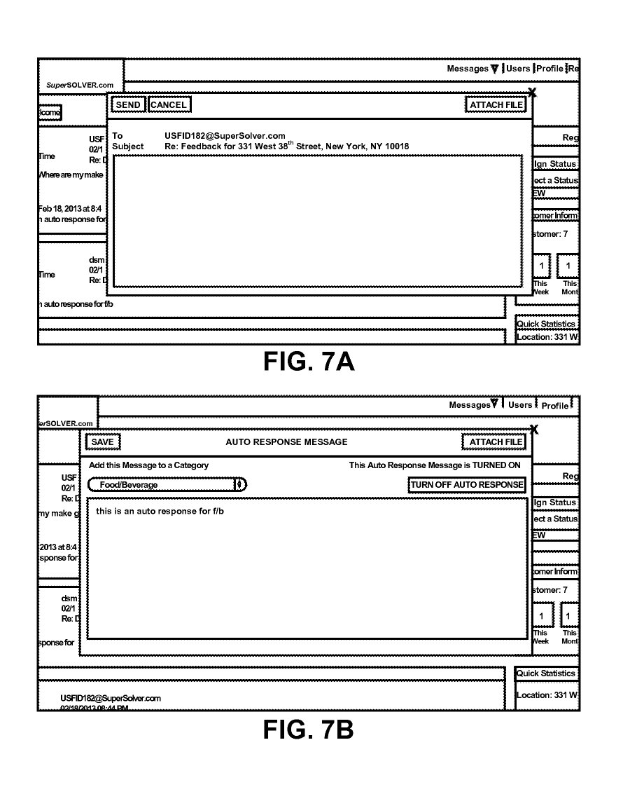

FIG. 7A shows another embodiment of an example screen display where an Enterprise can reply to an Individual's transmission of data. The Enterprise can reply to a Feedback delivered from the Mobile App as long as a Mobile App User that provided his e-mail address had sent the Feedback. When the Enterprise replies to the Feedback, the Message Processor delivers it to the Mobile App User.

FIG. 7B shows another embodiment of an example screen display where an auto-response can be created by an Enterprise. The Enterprise can create an auto-response message, and assign it to a Main Complaint Category associated with the Company. This means, if the Mobile App User submits a Feedback that includes a Sub-Complaint (that is under this Main Complaint) the Message Processor will automatically respond using this auto-response message.

FIG. 8A shows another embodiment of an example screen display that allows a an Enterprise to filter individual transmissions by status, type, date received, location, and time interval.

FIG. 8B shows another embodiment of an example screen display that lists Individuals transmissions in a tabular format. Through this screen, the User can access to an individual Message Thread.

FIG. 8C shows another embodiment of an example screen display where an Enterprise can interact with a specific Individual transmission and all responses to that transmission (a “thread”). A Single Message Thread can be accessed from All Feedback Threads screen. A Single Message Thread is represented by a Feedback ID and lists the Messages that are delivered back and forth between the Mobile App User and the Enterprise.

FIG. 8D shows another embodiment of an example screen display that displays summary information of Individual transmissions to a particular Enterprise. Quick Stats provides various stats on the Consumer, Main Complaints and Sub-Complaints associated with the current Feedback.

FIG. 8E shows another embodiment of an example screen display that allows an Enterprise to view and edit the status of a particular Individual transmission. Every new Feedback received by the Enterprise is automatically assigned NEW status. If an Auto-Response is sent, the Feedback is automatically assigned AUTO-RESPONSE SENT status. Other Feedback Status values can be manually assigned by the Enterprise and are dynamically retrieved from the database.

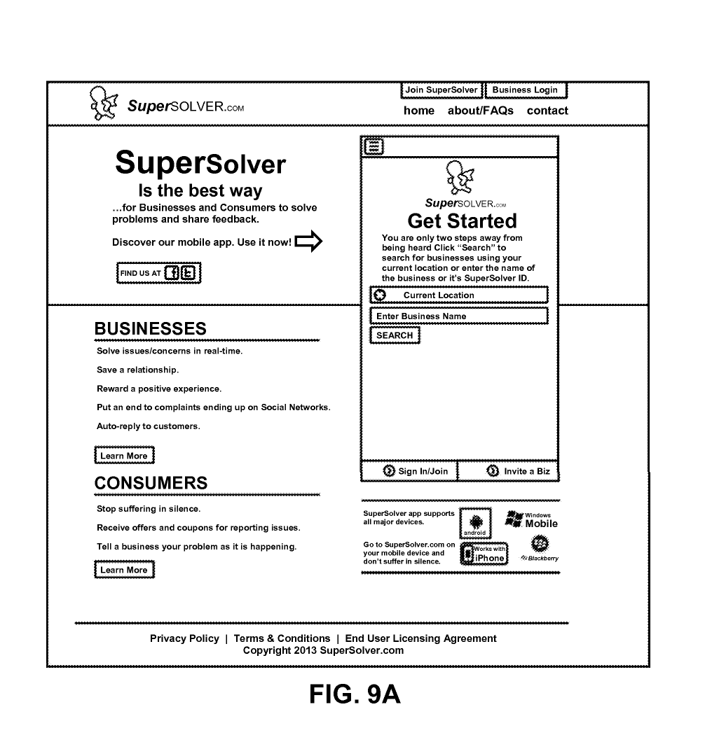

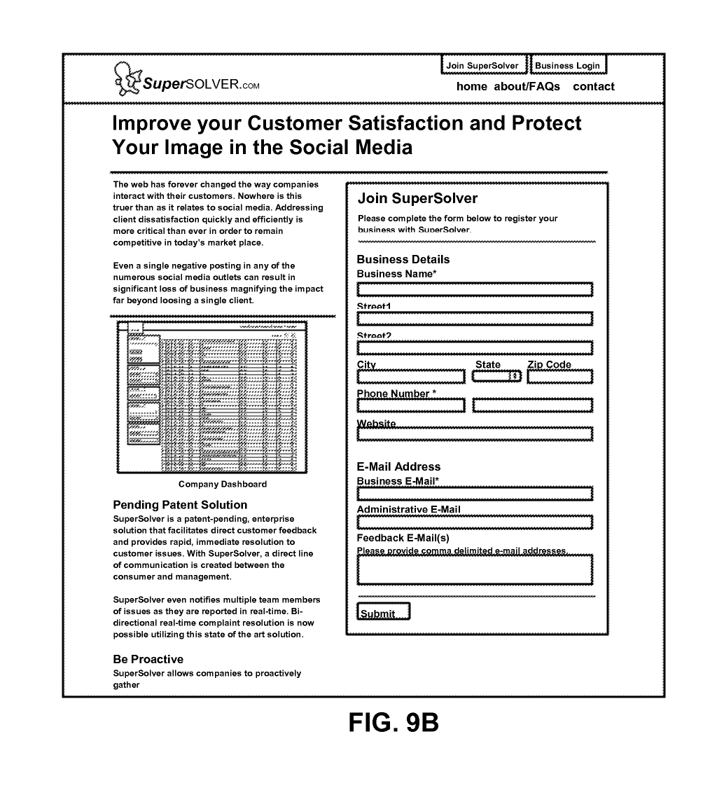

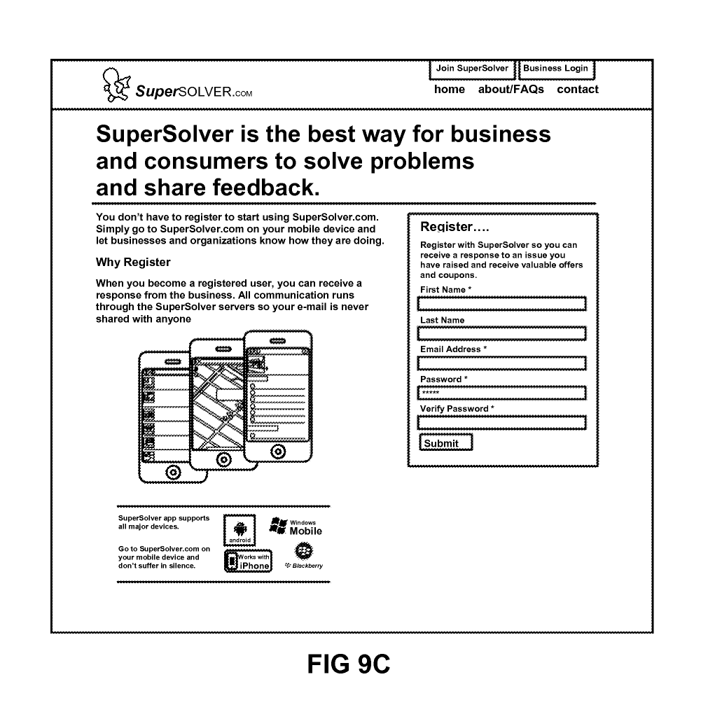

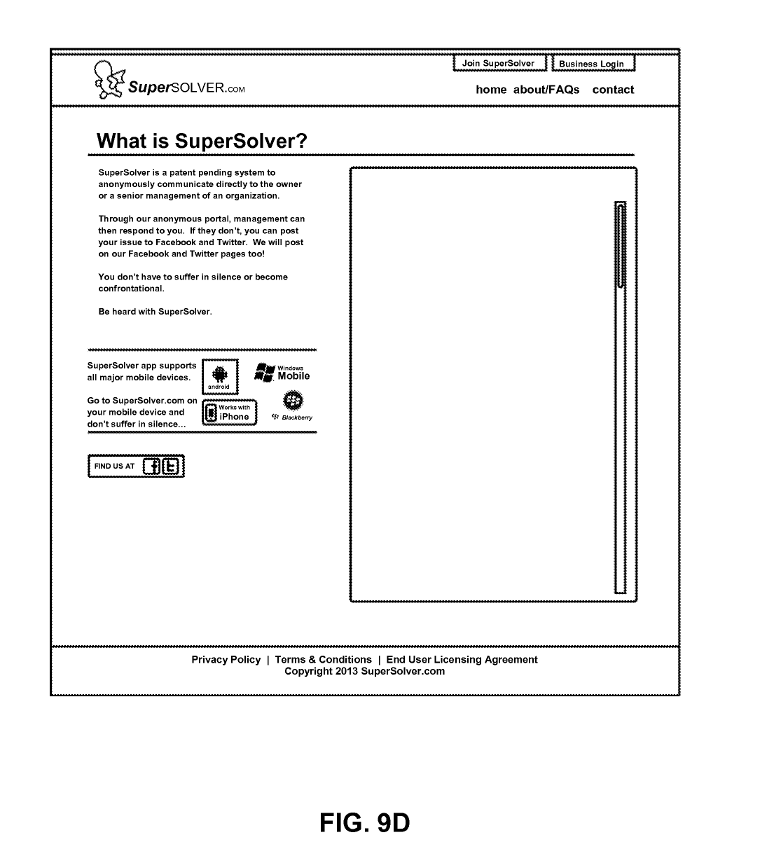

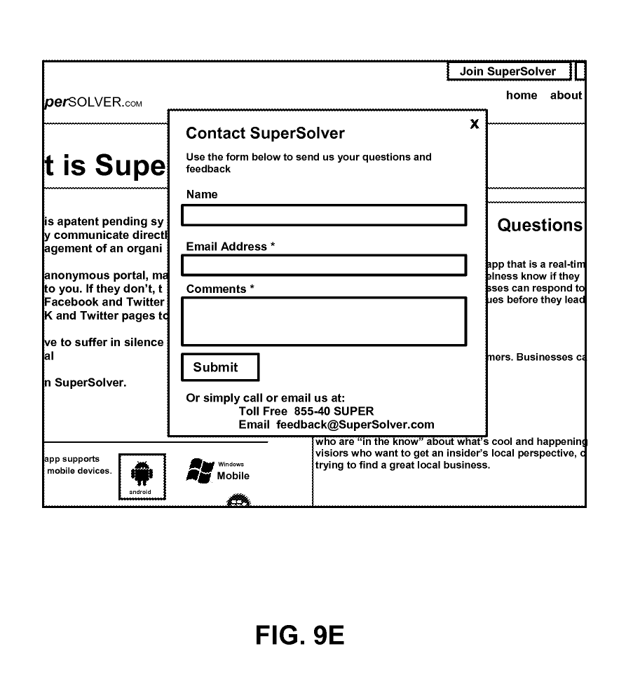

FIGS. 9A through 9E shows another embodiment of an example screen displays from a website describing the service to both Individuals who are consumers and to an Enterprise.

### CONCLUSION

Specific blocks, sections, devices, functions, processes and modules may have been set forth. However, a skilled technologist will realize that there are many ways to partition the system, and that there are many parts, components, processes, modules or functions that may be substituted for those listed above.

While the above detailed description has shown, described and pointed out the fundamental novel features of the invention as applied to various embodiments, it will be understood that various omissions and substitutions and changes in the form and details of the system illustrated may be made by those skilled in the art, without departing from the intent of the invention. The foregoing description details certain embodiments of the invention. It will be appreciated, however, that no matter how detailed the foregoing appears, the invention may be embodied in other specific forms without departing from its spirit or essential characteristics. The described embodiment is to be considered in all respects only as illustrative and not restrictive and the scope of the invention is, therefore, indicated by the appended claims rather than by the foregoing description. All changes which come within the meaning and range of equivalency of the claims are to be embraced within their scope.

1. A computer-implemented method for analyzing past electronic transmissions of an Individual to predict future electronic transmissions for the Individual comprising the steps of:
scheduling an electronic transmissions analysis on a server, the server being connected to a mobile device through the Internet;
collecting a set of past electronic transmissions submitted by the Individual;
employing at least one computer process to the set of past electronic transmissions to identify one or more patterns contained within the set of past electronic transmissions;
storing the patterns in a database;
monitoring for at least one condition associated with the one or more patterns;
if the at least one condition exceeds a specified threshold, predicting a probability of the Individual submitting a future electronic transmission; and
generating an alert notifying the Individual of the probability of the Individual submitting the future electronic transmission.

2. The computer-implemented method of claim 1 wherein the electronic transmissions analysis is scheduled at a predetermined time.

3. The computer-implemented method of claim 1 wherein the electronic transmissions analysis is scheduled manually.

4. The computer-implemented method of claim 1 wherein the electronic transmissions analysis is scheduled based on one or more predefined conditions.

5. The computer-implemented method of claim 1 wherein the specified threshold is the Individual approaching a certain physical location, nearing a certain time of day, nearing a particular day of a week, nearing a calendar date and combinations thereof.

6. The computer-implemented method of claim 1 wherein past electronic transmissions within the set of past electronic transmissions are selected based on a proscribed time window.

7. The computer-implemented method of claim 1 wherein the at least one of regression algorithms and machine learning techniques computes a probability that a future electronic transmission with certain characteristics will be submitted by the Individual given a set of parameters that includes time, location and previous Individual transmissions.

8. The computer-implemented method of claim 7 wherein the future electronic transmission is based on a pattern of occurrences where the Individual often feels a strong urge to perform a detrimental action within proximity to a certain location at a certain time of day.

9. The computer-implemented method of claim 25 wherein the at least one computer process is a regression algorithm, a machine learning technique or combinations thereof

10. A system for analyzing past electronic transmissions of an Individual to predict future electronic transmissions for the Individual, the system comprising:
at least one mobile device, and
at least one server, the at least one server including a processor and a memory, the memory including an operating system and an analysis module, wherein the mobile device is coupled to the at least one server over the internet and the analysis module is programmed to:
schedule an electronic transmissions analysis on the least one server;
collect a set of past electronic transmissions submitted by the Individual;
employ at least one computer process to the set of past electronic transmissions to identify one or more patterns contained within the set of past electronic transmissions;
store the patterns in a database;
monitor for at least one condition associated with the one or more patterns;
if the at least one condition exceeds a specified threshold, predict a probability of the Individual submitting a future electronic transmission; and
generate an alert notifying the Individual of the probability of the Individual submitting the future electronic transmission.

11. The system of claim 10 wherein the at least one computer process is a regression algorithm, a machine learning technique or combinations thereof.
